(19) United States
(12) Patent Application Publication
(10) Pub. No.: US 2013/0202016 A1
(43) Pub. Date: Aug. 8, 2013

(54) DATA TRANSFER CABLE SYSTEM AND METHOD

(71) Applicant: Ensphere Solutions, Inc., Santa Clara, CA (US)

(72) Inventors: Hessam Mohajeri, Los Altos Hills, CA (US); Emad Afifi, San Jose, CA (US)

(73) Assignee: Ensphere Solutions, Inc., Santa Clara, CA (US)

(21) Appl. No.: 13/756,251

(22) Filed: Jan. 31, 2013

Related U.S. Application Data
(60) Provisional application No. 61/594,977, filed on Feb. 3, 2012.

(51) Int. Cl. H04L 25/03; H04B 3/14

(52) U.S. Cl. CPC H04L 25/03878; H04B 3/14
USPC 375/219; 333/100; 375/295; 375/229

(57) ABSTRACT

Embodiments of a device include a receive multi-rate CDR unit communicatively coupled to a processor, the receive multi-rate CDR configured to receive signals from a cable and perform clock and data recovery on signals and a transmitter multi-rate CDR unit communicatively coupled to a processor, the transmit multi-rate CDR configured to send signals to the cable after performing clock and data recovery on the signals. Embodiments of the cable include a receiver equalizer configured to receive signals from a wire and a transmitter equalizer configured to receive signals from a connector of the cable and configured to transmit an equalized signal to the wire.

### CROSS-REFERENCE TO RELATED APPLICATIONS

This application claims priority under 35 U.S.C. §119(e) to U.S. Provisional Application No. 61/594,977, filed Feb. 3, 2012, the entire contents of which are incorporated herein by reference into the present disclosure.

### BACKGROUND

Data transfer cables are used to transfer data from one device to another. The amount of data that needs to be transferred between devices continues to increase from megabytes to gigabytes to terabytes. Cable technology continues to evolve and the advent of active optical cables (AOC) and active copper cables (ACC) allows devices to transfer data at a higher transfer rate. However, an increase in the complexity of the cables increases the circuitry within the cables, increases the cost of manufacturing the cables, and the cables need a power source to power the circuitry within the cable.

### SUMMARY OF THE DISCLOSURE

Embodiments of the cables described herein are directed at maximizing the data transfer rates while reducing the circuitry that is located in the cable or the connector head. In one embodiment, the cable achieves transfer rates from 1 Gbits/sec to 100 Gbits/sec or higher. Embodiments of a device include a receive CDR unit communicatively coupled to a digital receiver, framer or MAC units, the receive CDR unit configured to receive signals from a cable and perform clock and data recovery on signals and a transmitter CDR unit communicatively coupled to a processor, the transmitter CDR configured to send signals to the cable after performing clock and data recovery on the signals. Embodiments of a cable include a receive equalizer configured to receive signals from a wire and a transmitter equalizer configured to receive signals from a connector of the cable and configured to transmit an equalized signal to the wire.

### BRIEF DESCRIPTION OF THE DRAWINGS

FIG. 1 is schematic diagram of a device that can be connected to a cable according to an example embodiment.

FIG. 2 is a schematic diagram of a connector head of the cable shown in FIG. 1.

FIG. 3 is a schematic diagram of another embodiment of a connector head of the cable shown in FIG. 1.

FIG. 4 is a schematic diagram of another embodiment of a connector head of the cable shown in FIG. 1.

FIG. 5 is a schematic diagram of another embodiment of the device shown in FIG. 1.

FIG. 6a is a schematic diagram of another embodiment of the device shown in FIG. 1.

FIG. 6b is a schematic diagram of another embodiment of the device shown in FIG. 6a.

FIG. 7 is an example process that can be implemented by the devices and cables shown in FIGS. 1-6b.

### DETAILED DESCRIPTION

Active Copper Cable (ACC) and Active Optical Cable (AOC) include active electronics in the cable head located at the end of the cable prior to the connector. The active electronics for ACC includes equalizers and Clock and Data Recovery (CDR). The active electronics for the AOC includes optical components such as drivers, receivers, Vertical Cavity Surface Emitting Lasers (VCSEL) or lasers and CDRs. Accordingly, each cable can include two sets of active electronics at each end of the cable.

The active electronics in ACC compensates for the loss of data in copper cables at higher frequencies. The active electronic cleans the received signal and transmits the signal. Cleaning the signal can mean cleaning the noise, jitter and attenuation acquired by the signal as the signal passes through various components of the system. With copper cables the signal can be attenuated at higher frequencies. The noise, jitter and attenuation could create ISI (inter symbol interference). ISI can be reduced by an equalizer and jitter can be reduced by a CDR. The active electronics in the cable requires a power source and the power can be provided by one of the devices that is connected to the cable. Embedding the active electronics within the connector or the connector head can be disadvantageous because the connector head has a limited amount of space for the active electronics. According to one embodiment it can be advantageous to correct for the losses and crosstalk behind the connector instead of after the signal passes through the connector. In another implementation, short cables (2 inches to 2 feet in length), there is no need for the active electronics within the cable. Accordingly, a short cables may lack one or more of a power manager, receiver equalizer or transmit equalizer. Embodiments are directed to cables that enhance the cost, power and performance of AOC and ACC and also a way to decouple speed improvements of cabling from the internal electronics of the device. The AOC and ACC can include all of the active electronics including remitters or transmitters, equalizers and power supplies inside the connector heads.

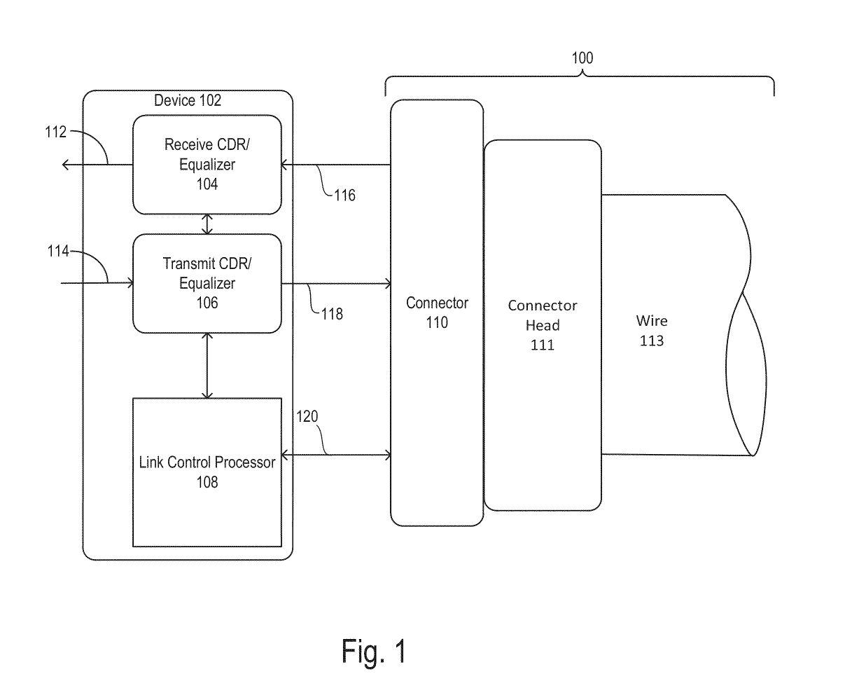

Referring to FIG. 1, FIG. 1 illustrates a cable 100 with a connector 110 that is connected to a device 102 according to an example embodiment. In other embodiments, the cable 100 can be removable or removably connectable from the device 102 using the connector 110. In one embodiment, removably connectable can mean that a user may join, fasten together, plug in two parts such that the connection between the two parts permits electrical or optical communication. Moreover, removably connectable can mean that a user may choose to selectively disconnect the two parts from each other such where no further electrical or optical communication occurs while the parts are disconnected. In one embodiment, the removably connectable functionality may be achieved through a spring that applies pressure to a part that helps retain the connection with another part. The retention of the connection may be severable by applies sufficient pressure to overcome the pressure that is applied on of the parts. FIG. 1 illustrates a wire 113 that is connected to a connector head 111 that is connected to a connector 110. The connector 110 can be electrically coupled to or decoupled from a device 102 to transmit signals, data or other information to or from the device 102. In one embodiment, the device 102 can be integrated into a user computer device that is configured to perform various tasks for the user. In this embodiment, the device 102 receives power from the user computer device and in turn provide power to the connector head 111. In another embodiment, the device 102 can be configured to be a stand-alone device that is connectable to a user computer device. In this embodiment, when the device 102 is connected to the user computer device, the device 102 can have a connector that receives electrical power for the various components of the device 102 and the device 102 can also transmit the power to the connector head 111. The device 102 can be configured to receive signal 116 from the wire 113 via the connector head 111 and the device 102 can be configured to send signal 118 to the wire 113 via the connector head 111.

The device 102 can include a receive CDR/equalizer 104 and a transmit CDR/equalizer 106. The receive CDR/equalizer 104 can receive signals 116 from the connector 110 and determine the clock frequency of the received signal using the link control processor 108. In one embodiment, the receive CDR/equalizer 104 can include an equalizer that reduces the intersymbol interference to allow recovery of the received or transmitted symbols in the signal. After determining the clock frequency the receive CDR/equalizer 104 can phase align the signal transitions in the data stream with a phase-locked loop (PLL). The signal can transition frequently enough to correct for any drift in the PLL's oscillator. Receive CDR/equalizer 104 can eliminate the jitter in the data signal using a phase detector and a low pass filter.

The transmit CDR/equalizer 106 can perform similar functions as the receive CDR/equalizer 104 except the transmit CDR/equalizer 106 receives signals from a user device, performs clock and data recovery, equalization and transmits the cleaned signal to the wire 113 via the connector 110 and the connector head 111.

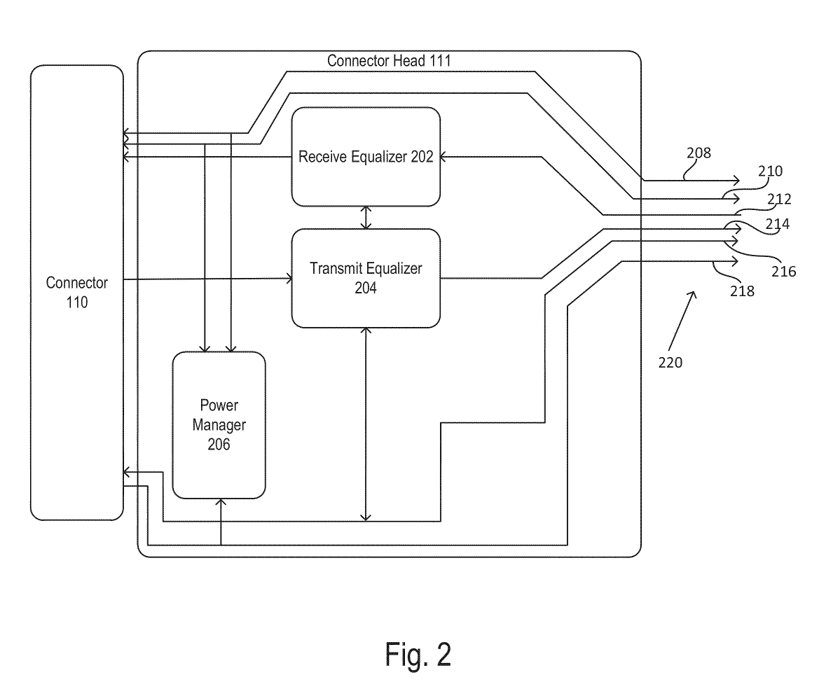

The link control processor 108 provides control signals such as, but not limited to, equalization parameters to the receive CDR/equalizer 104 and the transmit CDR/equalizer 106. In one embodiment, the equalization parameters may provide an equalizer with the determined clock frequency and a parameter or parameters that are determined based on the amount of equalization that is needed to be performed on the signal. The amount of equalization that is needed can be determined based on the detected attenuation and/or jitter in the signal. Based on the clock and data recovery operation the link control processor 108 can generate equalization parameters that can be sent to the connector head 111 which can have equalization circuitry as shown in FIG. 2. Some of the control signals generated by the link control processor 108 can be transmitted to the wire 113. In another embodiment, the receive equalization can be performed by automatically observing the signal and adjusting the parameters without receiving any input from the processor.

Referring to FIG. 2, FIG. 2 shows the connector head 111 that is in electrical communication with the connector 110 and wire 111. The connector head 111 includes a receive equalizer 202, transmit equalizer 204 and a power manager 206. Besides receiving and transmitting signals, the connector head 111 can receive and transmit various other signals. The receive equalizer 202 and the transmit equalizer 204 can receive signals and then transmit them after performing an equalization operations. The equalization operation can include reducing intersymbol interference to allow recovery of the received or transmitted symbols in the signal. In one embodiment, when the device 102 is connected to the connector head 111 via the connector 110, the system can include two equalizers the receive direction and two equalizers in the transmit directions. Providing two equalizers in one path both before and after the connector can permit the length of the wire to be longer than in other embodiments. For example, the connector head can receive one or more voltage supply signals 208 and 210 that can provide power to the entire wire 111. The voltage signal 208 can be referred to as VCC1 and the voltage signal 210 can be referred to as VCC2. As shown in FIG. 2, the power manager 208 can receive power from the voltage signals 208 and 210. In one embodiment, the voltage of VCC1 and VCC2 can be different from each other. In yet another embodiment, VCC1 and VCC2 can have the same voltage. Transmit, receive commands and equalization parameters that are generated by the link control processor 108 can be transmitted via line 216 to the wire 113 and the connector head 111. In one embodiment, the equalization parameters may provide an equalizer with the determined clock frequency and a parameter or parameters that are determined based on the amount of equalization that is needed to be performed on the signal. The amount of equalization that is needed can be determined based on the detected attenuation and/or jitter in the signal. The signal on line 216 can provide the equalizers 202 and 204 with control signals to equalize the receive and transmits signals. The ground signal 218 can be provided to the wire 111 and can connect to the power manager 206. As shown in FIG. 2, the connector head 111 can be absent any CDR circuitry and can include equalization circuitry.

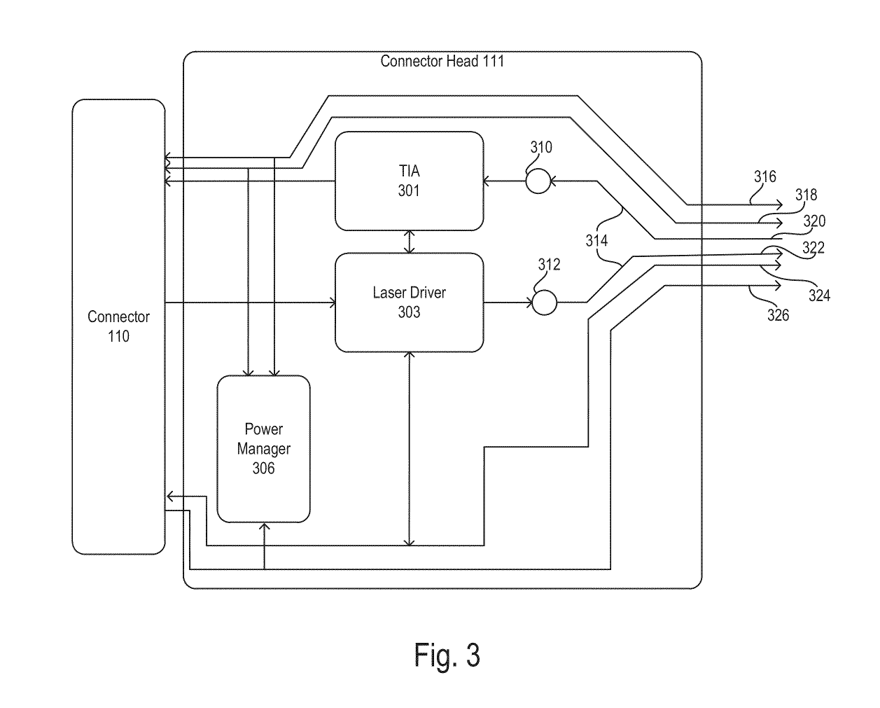

FIG. 3 shows another embodiment of the connector head 111. In this embodiment, the connector head 111 can be an optical wire connector head. Instead of the equalizers from FIG. 2, the connector head from FIG. 3 includes a transimpedence amplifier optical receiver (TIA 301) and a laser driver 303. The TIA 301 can receive signals from the photo detector (PD) 310 via fiber optic cable 314. The TIA 301 can convert the light signals that were received by the PD 310 into an electrical data stream and transmit the electrical signal through the connector 110 to the receive CDR 104. The laser driver 303 can be configured to receive a transmit signal from the connector 110 and forward the signal to a VCSEL 312 (vertical-cavity surface-emitting laser). In turn the VCSEL 312 can transmit the transmit signal via fiber optic cable 314 to the wire. The power manager 306 can receive one or more VCC signals 316 and 318 and the power manager can provide electrical power to the TIA 301, PD 310, laser driver 303 and the VCSEL 312. The laser driver 303 can receive signals from the transmit CDR 106.

Various advantages can be realized by the architecture shown in FIGS. 1-3. The cable shown in FIGS. 1-3 can achieve a tremendous cost saving and improve the power dissipation that is needed inside the cable. Also the architecture illustrated in FIGS. 1-3 moves the complexity of the design from the cable to the device 102 of the user device where power dissipation and space for components can be more readily available than the connector head. Since the CDRs are after the connector the signal integrity for the cable shown in FIGS. 1-3 is improved and the cable results in a better BER (bit error rate) performance.

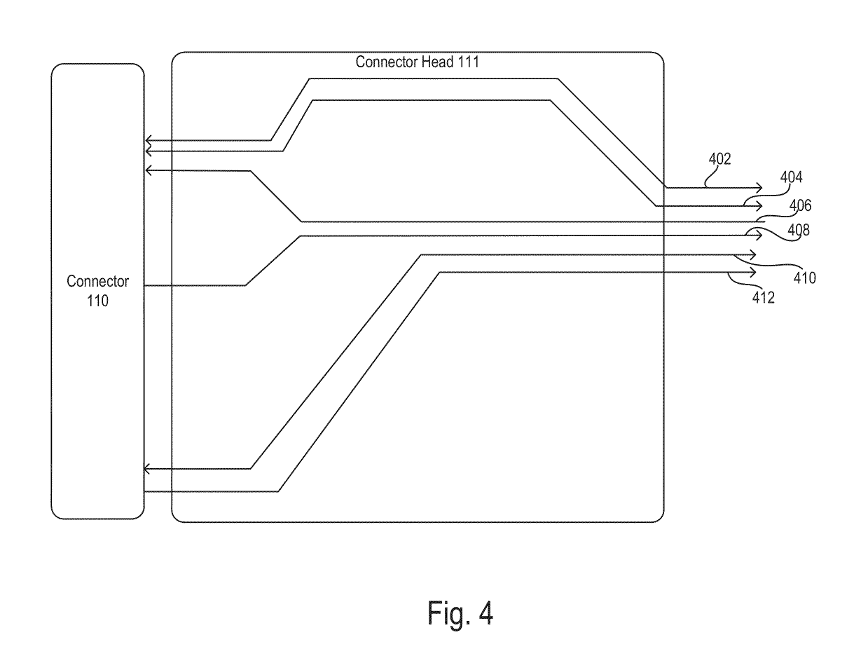

FIG. 4 illustrates another embodiment of a cable and connector head 111. In this embodiment, the active electronic components from FIGS. 2 and 3 are removed from the connector head 111 because the cable illustrated is designed to be short. Example length of the cable can be as small as 3 inches to as long as about 2 feet. In one embodiment, about refers to up to 5% deviation in each direction. In other embodiments, the length of the cable can be 6 inches, 1 foot or 1.5 feet. The connector head displays various cables VCC1 402, VCC2 404, Receive cable 406, Transmit cable 408, transmit and receive command 410 and ground 412 being transmitted without the cable requiring any power from the device 102. The device 102 will continue to provide the CDRs and the link control processor, but when the length of the cable is limited the equalizers, TIA and laser driver do not need to maintain the transmitting speed of the cable.

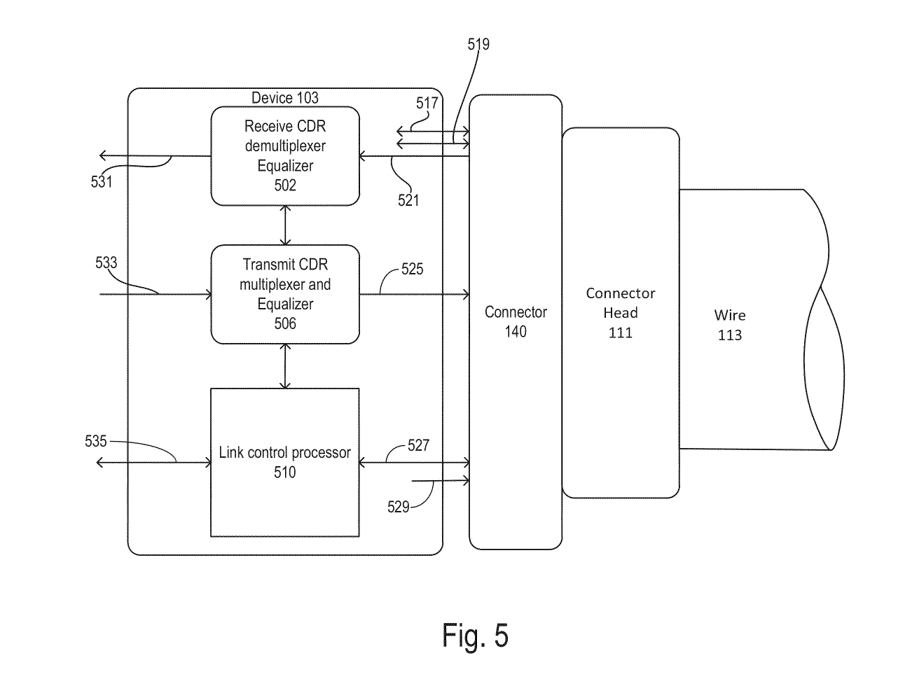

Referring to FIG. 5, FIG. 5 is a schematic diagram of a device 103. Device 103 can include a receive CDR demultiplexer/equalizer 502, transmit CDR multiplexer/equalizer 506 and link control processor 510. Receive line 531 can include multiple electrical connections representing multiple lanes of data signals that can be multiplexed using the receive CDR demultiplexer/equalizer 502. The multiple lanes can be used based on the rate of transfer. For example, the receive CDR demultiplexer/equalizer 502 can handle data speeds of up to 10 Gigabits per second, 20 Gigabits per second or 40 Gigabits per second. Receive line 521 can be a single lane of 10 Gigabits per second, 20 Gigabits per second or 40 Gigabits per second or higher. Accordingly, when the receive CDR demultiplexer/equalizer 502 receives a signal at one speed the signal can be transmitted to the user device at the highest speed possible.

Similarly, line 533 represents multiple lanes that can transmit data at different data transfer rates. The transmit CDR multiplexer/equalizer 506 is configured to convert the received data into the highest speed that the cable can handle and transmit the signal out via line 525. The schematic shown in FIG. 5 will allow user devices to transition to a higher data transfer rate without needing to change the hardware within the user device. This added benefit of moving the CDRs to the user device allows a continued innovation in the field of input and output data transfer rates. In one embodiment, the receive CDR demultiplexer/equalizer 502 and the transmit CDR multiplexer/equalizer 506 can detect what data transfer rate the wire that is connected to the device 103 can handle. Although 10, 20 and 40 Gigabyte rates are discussed above the data transfer rate can also be a fraction and need not be limited to an integer. The schematic diagram shown in FIG. 5 can be applied to both optical wires and copper wires. Multilevel signaling and/or more complex modulations can also be used after the multiplexer and demultiplexer and the data transport do not need to be non return to zero (NRZ).

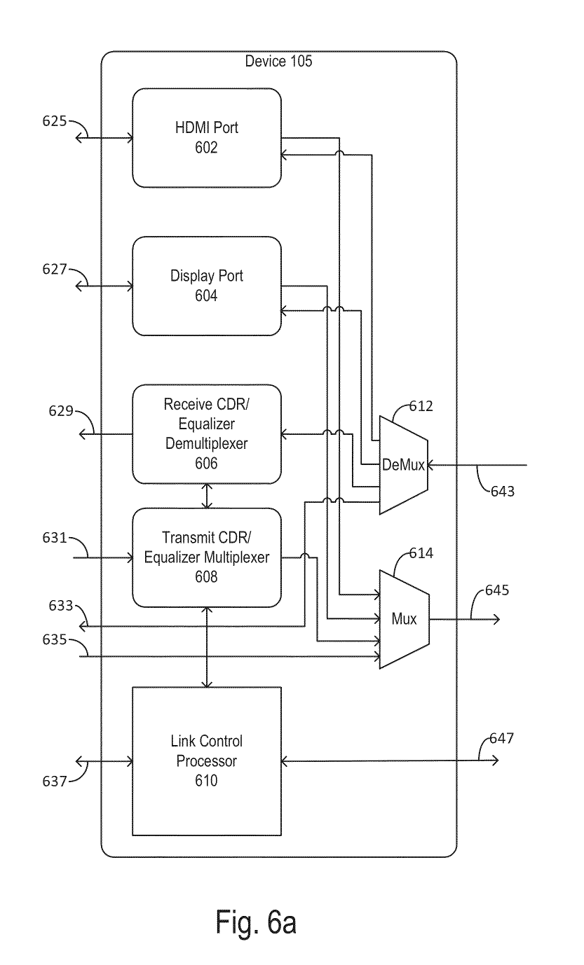

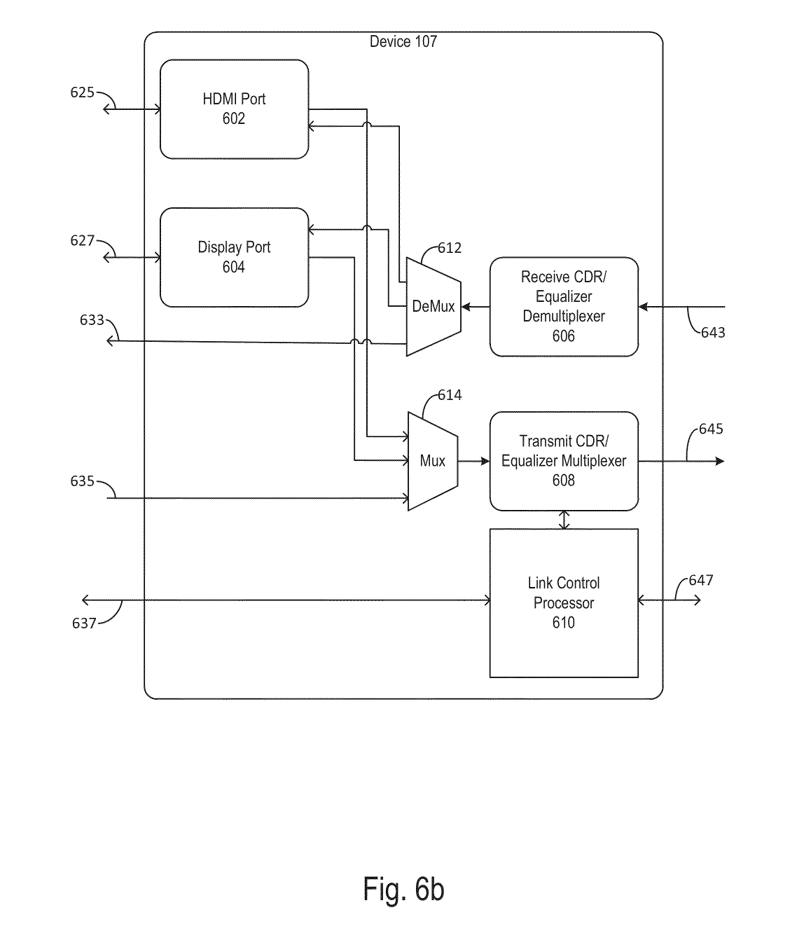

FIG. 6a is a schematic diagram of a device 105. Integration of legacy components can allow a user to reduce the cost or improve the functionality of the device 140. In another embodiment, the connector can function as a different interface which requires data to be multiplexed into the same set of connector pins. By way of example, FIG. 6a shows a display port and HDMI® ports but other ports such as, but not limited to PCI-e, USB and other connectors can be integrated and multiplexed into the device 105. One side of the device 105 can use an adapter to support legacy connectors. Once the adapter is plugged into the port the device 105 can determine the configuration and appropriately connects the right resource to the connector. The device 105 can also support legacy connectors as a pass-through functionality. In one embodiment, pass-through can mean that the signal comes in from one side and leaves from other side with no processing applies on it. Basically the chip acts as a switch and sends the signal through. As an added benefit the same CDR can be used for recovery display port and HDMI® functions and reduce the cost of such chips.

The device 105 includes an HDMI® port 602, display port 604, receive CDR/equalizer demultiplexer 606, and transmit CDR/equalizer multiplexer 608. The device 105 also includes receive demultiplexer 612 and transmit multiplexer 614. The device 105 provides bypass lanes 633 and 635 for legacy devices and they are selected by the processor for link control 610 based on the control signals that are provided to the demultiplexer 612 and multiplexer 614. The demultiplexers 612 and multiplexer 614 can be configured to receive and transmit signals to and from the HDMI® port 602, display port 604, receive CDR/equalizer demultiplexer 606, and transmit CDR/equalizer multiplexer 608.

FIG. 6b is a schematic diagram of a device 107. In this embodiment, the receive CDR/equalizer demultiplexer 606 and the transmit CDR/equalizer multiplexer 608 are located prior to the signal is transmitted to or from the demultiplexer 612 or multiplexer 612. Accordingly, the interference introduced by the demultiplexers 612 and multiplexers 614 is minimized. In yet another embodiment, instead of using a multiplexer a pass through might be an used. The pass through implementation can reduce the latency in the circuit. A pass through in this implementation can include buffering the signal and passing it through a passive multiplexer without retiming. In one implementation passing through might include performing equalization operations on the signal.

In yet another embodiment, the receive CDR/equalizer demultiplexer 606 can receive signals after they are passed through the demultiplexer 612 while the transmit CDR/equalizer multiplexer 608 receives signals from the multiplexer 614.

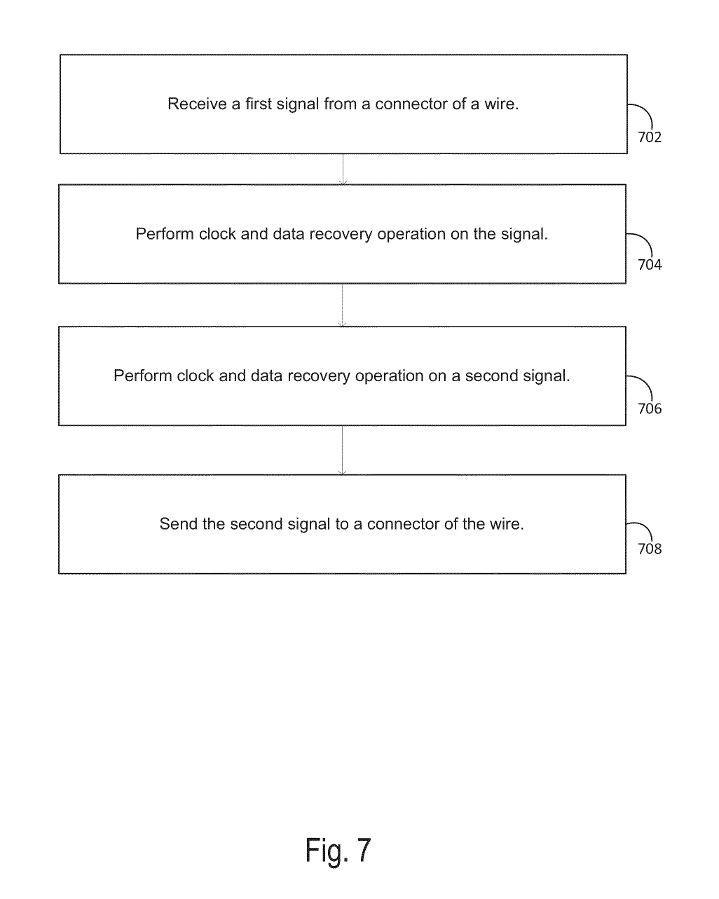

FIG. 7 is an example process that can be implemented by the devices and cables shown in FIGS. 1-6. At block 702, a first signal from a connector of a wire can be received by the receive CDR. Next, at block 704, the receive CDR can perform a clock and data recovery operation on the received signal. In one embodiment, the received signal can be equalized by a receive equalizer. At block 706 the transmit CDR can receive a second signal that needs to be transmitted and perform a clock and data recovery operation on the second signal. Next at block 708, the transmit CDR can send the second signal to a connector of a wire.

Availability of high-speed electronics and optics permits high-speed data transfer between user devices and other peripherals using the devices and cables discussed above. Various advantages can be realized by the embodiments discussed above. For example, minimal electronics integrated inside the wire or cable. The reduction of the complexity of components located within the cable can reduce the cost of the cable, reduce heat generation within the cable, and reduce power dissipation. The devices 102, 103 and 104 can use more complex modulation because they have a readily available power source from the user device, which is a personal computer or peripheral. Embodiments of the device as discussed above are compatible with other legacy connectors that can be integrated on the peripheral side in order to reduce cost and improve performance. The legacy connectors will use the same connector and the processor can configure the device according to the ports that are needed. The use of optical or copper connectors is seamless and the user can use either technology that is suited for the users' application. Having the CDR before the connector creates better signal conditioning and increases BER (bit error rate) performance. Having a bypass inside the CDR chip can also accommodate legacy cables. Although the drawings illustrate one channel for transmit and receive signal, other embodiments can use multiple channels. The blocks are also shown as separate functions but to reduce cost all blocks relating to a single item can be integrated into an application specific integrated circuit (ASIC) as considered appropriate.

Those of skill would further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

In one or more exemplary embodiments, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. Storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein can be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A device, comprising:
a receive multi-rate CDR unit communicatively coupled to a processor, MAC unit or processing unit, the receiver multi-rate CDR configured to receive signals from a cable and perform clock and data recovery on signals;
a transmit multi-rate CDR unit communicatively coupled to a processor, the transmitter multi-rate CDR configured to send signals to the cable after performing clock and data recovery on the signals; and
wherein the device is removably connectable to a wire.

2. The device of claim 1, wherein the device is connectable to the cable using a connector.

3. The device of claim 1, wherein the multi-rate CDR unit receives equalized signals from the cable; and wherein the transmitter multi-rate CDR unit is configured to transmit signals to a transmitter equalizer that is located on the cable.

4. The device of claim 2, wherein the device lacks a signal equalizer.

5. The device of claim 2, further comprising a processor for link control that generates transmit and receive commands that are configured to be transmitted to the wire using the connector.

6. The device of claim 5, wherein the processor generates equalization parameters for a transmit equalizer and a receive equalizer; and
wherein a transmit equalizer is configured to equalize the signal received from the transmit multi-rate CDR unit based on the control signals generated by the processor;
wherein a receive equalizer in a connector head of the wire is configured to equalize the signal that is sent to the receive multi-rate CDR unit based on the control signals generated by the processor.

7. A cable, comprising:
a receiver equalizer configured to receive signals from a wire;
a transmitter equalizer configured to receive signals from a connector of the cable and configured to transmit an equalized signal to the wire; and
wherein the cable is removably connectable to a device.

8. The cable of claim 7, wherein the wire includes a plurality of wires for transmitting power and data.

9. The cable of claim 7, wherein the cable lacks a clock and data recovery unit.

10. The cable of claim 7, wherein the receiver equalizer is configured to receive signals with a clock and data recovery having been performed by the device located outside the cable.

11. The cable of claim 7, wherein the transmitter equalizer is configured to receive signals with a clock and data recovery having been performed by the device located outside the cable.

12. The cable of claim 7, further comprising a connector head configured to transmit and receive signals from a processor that is located off the cable and the processor is configured to generate transmit and receive commands that are configured to control the components in the connector head of the cable.

13. The cable of claim 7, further comprising a receive equalizer and a transmit equalizer configured to receive equalization parameters from a processor through the connector.

14. The cable of claim 13, wherein the transmit equalizer is configured to equalize the signal based on the equalization parameters;
wherein the receive equalizer is configured to equalize the signal based on the equalization parameters.

15. A method of transmitting information, comprising:
receiving a first signal from a connector of a wire;
performing clock and data recovery operation on the first signal;
performing clock and data recovery operation on a second signal; and
sending the second signal to a connector of the wire.

16. The method of claim 15, wherein sending the signal to a connector including sending a signal to an equalizer.

17. The method of claim 15, further comprising providing a device that comprises:
a receiver multi-rate CDR unit communicatively coupled to a processor, the receiver multi-rate CDR configured to receive signals from a cable and perform clock and data recovery on signals; and
a transmitter multi-rate CDR unit communicatively coupled to a processor, the transmitter multi-rate CDR configured to send signals to the cable after performing clock and data recovery on the signals.

18. The method of claim 17, further comprising providing a cable that comprises:
a receiver equalizer configured to receive signals from a wire;
a transmitter equalizer configured to receive signals from a connector of the cable and configured to transmit an equalized signal to the wire.

19. The method of claim 17, wherein the device is connectable to the cable.

20. The method of claim 17, further comprising providing a power management unit in the cable.
